(19) United States
(12) Patent Application Publication
(10) Pub. No.: US 2020/0117897 A1
(43) Pub. Date: Apr. 16, 2020

(54) Adaptive Artificial Intelligence Training Data Acquisition and Plant Monitoring System

(71) Applicant: Walt Froloff, Aptos, CA (US)

(72) Inventor: Walt Froloff, Aptos, CA (US)

(21) Appl. No.: 16/160,871

(22) Filed: Oct. 15, 2018

(51) Int. Cl. G06K 9/00; G06N 20/20; G06N 3/04; G06K 9/20

(52) U.S. Cl. CPC G06K 9/00657; G06N 20/20; G06K 9/209; G06K 9/00771; G06N 3/04

(57) ABSTRACT

A system for adapting an in situ wireless sensor network monitoring system to AI analytic trained automated crop or plant monitoring system, by having non-experts with exemplars of watched-for pestilence accumulating wireless sensor image data into identified suspect pest labeled image objects for training AI analytics. Non-experts view and compare suspect pestilence and harms, labeling objects matching exemplars and accumulation a minimum set of training images for training an AI analytic program. Once trained the AI analytic is installed for monitoring for positive identified labeled trained objects identified in sensor data images.

### BACKGROUND

### Field of the Invention

The present invention generally relates to the creation and acquisition of training data for Artificial Intelligence machine learning programs, and more specifically to agricultural, community and multi-entity machine learning training data creation, acquisition, integration and use adaptively in AI machine learning program monitoring for pestilence, plant disease and other crop threats.

### Common Plant Diseases

Before one can successfully cultivate plant crops one needs to know what's affecting them. There are many kinds of pestilence and diseases which can threaten plants. The symptoms are known by inspection. A partial list is as follows:

Blights, when plants suffer from blight, leaves or branches suddenly wither, stop growing, and die. Later, plant parts may rot. These kinds of crop or plant threat include Fire Blight, Alternaria Blight, Early Blight, Phytophthora Blight—Late Blight. Bacterial Blight, Cankers: Cytospora Canker, Nectria Canker. Rots are diseases that decay roots, stems, wood, flowers, and fruit. Some diseases cause leaves to rot, but those symptoms tend to be described as leaf spots and blights. Rots can be soft and squishy or hard and dry. They are caused by various bacteria and fungi. Many are very active in stored fruits, roots, bulbs, or tubers. Fruit Rots, Root or Stem Rots, Mushroom Rot, Wood Rot. Rusts, Asparagus Rust, Wheat rust, cedar-apple rust, and white pine blister rust, Wilts, Stewart's Wilt, Fusarium and Verticillium, Wilt, Anthracnose, Club Root, Downy Mildew, Galls, Leaf Blisters and Curls, Leaf Spots, Blackspot, Molds, Powdery Mildew, Scabs, Smuts, Viruses, Nematodes. Common Cultural Disorders including Cold Injury, Heat Injury, Moisture Imbalance, Wind Damage, Salt Damage, Ozone Damage.

Then there is the insect pestilence and the issue on how to localize and identify the threats to plants from these invaders. The more well known examples of devastation from insect pestilence unchecked are the Grape Phylloxera and Glossy Winged Sharp Shooter threats to viticulture, white fly on cannabis, or brown moth to everything.

### Sticky Traps

Currently sticky traps are used in plant or crop monitoring programs. Sticky traps can provide warning of pest presence before plant damage becomes devastating, alerting owners, farmers, counties, cities, regional entities, to step up visual inspections. Some entire counties fearing infestation will implement programs that sparsely located data from sticky traps in residential communities as part of a community service. Once pests are confirmed in to be in the area, slower acting control strategies can be utilized that are more environmentally-friendly and safer for people.

Sticky traps can also indicate greenhouse hot spots and can document pestilence migration patterns when placed near doors and vents. Data collected from sticky traps can be used to evaluate pest management control actions, including the use of natural enemies.

However, installing and replacing traps is labor intensive. The number of traps needed depends on many factors, including the main target pest. Inspection of sticky traps is very labor intensive and recommended at least once or twice weekly and replaced after inspection unless the traps are reused. Reusing traps saves on the cost but counting insects on reused traps is more labor-intensive. Typically traps are not be left up for long periods because they become caked with insects, making it difficult to make accurate and quick counts. What is needed are ways to continually monitor the traps taking into account only the latest insects captured.

Identification and insect count are also very large resource sinks to labor.

Accurate data depends on careful identification of the insects. Typically 10-15× hand lens are used to determine identifying characteristics of insects caught on sticky traps. High-quality color photographs and line drawings of commonly trapped insects are available from public sources.

What is needed is an automated way to discover what is attacking or ailing a crop or region and warn people early or at least in time to save the crop or region with the outbreak. Since crop disease or pestilence symptoms are discovered by inspection, image data from sensors can be obtained to monitor the crop health remotely but are monitored by non-domain experts.

Many current methods for using wireless sensors for monitoring are impractical, relying on humans to regularly change batteries and put out recorders, or expensive, requiring huge reams of data to be sent via satellites.

### The AI Solution

AI offers ways to analyze image data for identifying specific targets in an image. However, obtaining good image training data for an AI machine learning, ML, analytic program is a huge and expensive problem. We know this from current AI program creations by Google®, Facebook®, IBM® and others. Facebook® paid for Instagram® $1 Billion to receive 3.5 billion images to train their image recognition AI. Then they claimed their AI analytic was 10% better than Google's®, AI analytic for spotting targets in website images. The user's of Instagram®, felt violated as the new owner FB® appropriated the user labeled images for training data for their image identifier AI program.

The Instagram®, photos that had been annotated by users with labels were used to train their own image recognition models. “The “pre-training” research focused on developing systems for finding relevant labels; that meant discovering which labels were synonymous while also learning to prioritize more specific labels over the more general ones. The privacy implications here are always on the jagged edge of legal. On one hand, Facebook®, is only using what amounts to public data (no private accounts), but when a user posts an Instagram®, photo, they may not be aware are they that they're also contributing to a database that's training deep learning models for a tech mega-corp.

Creating labels and then sorting on the labels for specific training data is problematic also. The largest tests used 3.5 billion Instagram®, images and 17,000 labels. There were a couple of tasks in sorting out the labels. FB®, needed to discover which ones were synonymous, and prioritize specific over general labels. Of course, the models were centered on “object-focused image recognition,” Or, the image recognition technology focused on more “concrete” things like food, plants, dog breeds, animals, and so on.

On the medical AI front, IBM® bought 3 Healthcare companies $3 Billion to acquire 3.5 Billion images for which to train Dr Watson, industry standard Medical AI analytic. Google®, Celerity partnered with HC Hospital for patient Images to train their AI. Images like CAT scans, X-rays and mammograms, IBM®, researchers estimate, represent about 90 percent of all medical data today. The images and a patient's electronic health records are typically separate. So, for example, a radiologist might examine thousands of patient images a day, but only looking for abnormalities on the images themselves rather than also taking into account a person's medical history, treatments and drug regimens.

Google®, was handed 1.6 million record patients' files and medical history without permission, in NHS deal. Patients, owners of their data, were not consulted. Privacy advocates exposed the public's lack of power and control over their own personal details remains at issue.

What is needed are better ways to obtain AI training data, ways that don't legally cheat owners of their image data, ways that make labeling easier and better, ways that don't breach the privacy of individuals without their express consent, and ways that don't require the user be a multinational conglomerate to finance the cost of building a system to monitor the crops.

AI input images for training AIs are expensive, fraught with privacy and image ownership issues. But worst of all, only the very largest corporate players can afford to create an AI and then train it to look for specific targets. What is needed is ways to democratize AI training data images so that other than mega-corps can own them.

Machine learning is a field of computer science that uses statistical techniques to give computer systems the ability to “learn”, progressively improve its ability to identify the target labeled image entity sought. These can come from Supervised or Unsupervised methods.

Supervised learning is the machine learning phase of deriving a function that maps an input to an output based on example input-output pairs. It infers a function from labeled training date consisting of a set of training examples. In supervised learning, each example is a pair consisting of an input object, typically a vector, and a desired output value, aka the supervisory signal. A supervised learning algorithm analyzes the training data and produces an inferred function, which can be used for mapping as yet unidentified data instance as lying in the labeled positive and negative sets. What is needed are training data sets that can be used in Supervised learning for training machine learning AI programs.

In Semi-supervised learning the computer is given only an incomplete training signal: a training set with some (often many) of the target outputs missing. Yet another related method is Active learning, whereby the computer can only obtain training labels for a limited set of instances (based on a budget), and also has to optimize its choice of objects to acquire labels for. When used interactively, these can be presented to the user for labeling. What is needed are application of methods that provide aid in acquiring labeled training data for agricultural data AI programs.

High-quality labeled training datasets for supervised and semi supervised machine learning algorithms are generally difficult and expensive to create and or obtain. Consequently only the very large corporate entities expending billions of dollars can afford to purchase the labeled training data. At times these acquisitions come at the expense of individuals' privacy and ownership rights. What is needed are ways to acquire labeled training data at little additional cost to individuals and to companies seeking to build systems which can benefit from AI programs.

### Sensors

There are many kinds of sensors that can be used to monitor crops, as there are many kinds of crops, crop disease and pestilence symptoms and sensor technologies. Image sensors are the most popular, but audio and RF sensors are all possible. Wireless sensor networks have been discussed and designed. The usual camera for image data is perhaps the cheapest and easiest to manage. There are various lenses for cameras that can be used to advantage, including fisheye, telephoto for close-ups, wide-angle or Multispectral Imaging camera sensors. The power of any lens is in its design. Images can also be obtained from other sensors as well including multispectral, audio, IR, thermal, etc.

Multispectral imaging is an emerging non-destructive technology. Its potential for symptom discrimination and identification of crop diseases and pestilence is emerging. Normalized canonical discriminate analysis, nCDA, and principal component analysis, PCA, can be used to analyze and compare the image results.

Remote sensing applications in agriculture are based on the interaction of electromagnetic radiation with soil or plant material. Typically, remote sensing involves the measurement of reflected radiation, rather than transmitted or absorbed radiation. Remote sensing refers to non-contact measurements of radiation reflected or emitted from agricultural fields. The platforms for making these measurements include satellites, aircraft, tractors, drones and hand-held sensors. Measurements made with tractors and hand-held sensors are also known as proximal sensing, especially if they do not involve measurements of reflected radiation. In addition to reflectance, transmittance and absorption, plant leaves can emit energy by fluorescence or thermal emission. Thermal remote sensing for water stress in crops is based on emission of radiation in response to temperature of the leaf and canopy, which varies with air temperature and the rate of evapotranspiration. The amount of radiation reflected from plants is inversely related to radiation absorbed by plant pigments, and varies with the wavelength of incident radiation. Plant pigments such as chlorophyll absorb radiation strongly in the visible spectrum from 400 to 700 nm, particularly at wavelengths such as 430 (blue or B) and 660 (red or R) nm for chlorophyll a and 450 (B) and 650 (R) nm for chlorophyll b.

What is needed are smart sensors and reporting of relevant data that can be processed to eventually automate the process of human analysis of the data. What is needed are integrated sensors and technology that relieve humans from the arduous and labor intensive tasks of scanning images and data to determine threats to plants and raise early alerts so that these can be managed before they become significant and costly.

### Sticky Trap Sensors

Using sticky traps to monitor pests is a standard greenhouse practice that can helps reduce overall pest management costs when coupled with plant inspections. Sticky traps are also a tool for identifying adult insect pests present in a greenhouse, including whiteflies, thrips, fungus gnats, shore flies and leafminers. Sticky traps can also be used to monitor adult parasitoids released in biological control programs.

Sticky traps provide an easy method for estimating pest population densities. When the timing of pest control actions is based on these relative estimates along with plant sample data from visual inspections, there is generally a reduction in pesticide use. As a result, there are fewer problems with pesticide resistance, less worker exposure to pesticides, reduced pesticide runoff and improved plant quality with less pesticide-induced phytotoxicity symptoms.

What is needed are automated insect and plant sensors that can capture data for analysis and early warning, data that can be captured by non-professionals and converted into automated pestilence and crop disease sentinels.

### SUMMARY

The present invention discloses a system for adapting an in situ wireless sensor network monitoring system to AI analytic trained automated crop or plant monitoring system, accumulating wireless sensor image data into identifiable labeled image objects for training AI analytics. A plurality of integrated sensors network wirelessly collecting plant and insect primary sensor data have logic for primary sensor data transfer with associated sensor metadata onto a database, and logic for partitioning primary sensor image data into insect pestilent and plant images. Non-expert monitoring demark suspected objects in the data by digitally bounding border demarking an object in a partitioned data image, view display comparison of exemplar images of specific identified insects and plant harms with the demarked image data objects. The demarked and labeled object non-expert identified positively matching exemplar are grouped with a positive labeled image set or non-matching image data grouped with negative image data set if not matching. Preset minimum numerical count for threshold of training image data for a specified label of positive and negative data image set counts are used as thresholds for the minimum number of images needed accumulated before forwarding the data sets reaching threshold specific image label count as input training data to an AI machine learning program for creating an AI analytic capable of identifying the specific labeled image object in primary sensor data images. The trained executing AI analytic scanning a plurality wireless sensor data images for pestilence and plant objects matching positive trained identified labeled objects, where the analytic program is responsive to monitoring for specifically trained positive identified labeled positive label trained objects identified in sensor data images so that a system with a plurality of wireless integrated sensor network continuously monitoring plants for pestilence and other plant harms can timely raise alerts of found labeled positively identified insects or plant harm without human visual intervention, alerts retaining sensor meta data, time and location of sensor data triggering image alert.

[symbol]

[symbol]

### BRIEF DESCRIPTION OF DRAWINGS

FIG. 1 is a high level block diagram illustrating sensor placement in an embodiment of the invention.

FIG. 2 illustrates a integrated sticky trap sensor in an embodiment of the invention.

FIG. 3 illustrates the components and logic in sticky trap sensor in an embodiment of the invention.

FIG. 4 is a high level flow diagram showing system architecture developing training data in accordance with an embodiment of the present invention.

FIG. 5 is a high level flow diagram showing system architecture using the adapted trained AI programs with image meta data in accordance with an embodiment of the present invention.

FIG. 6 is a flow diagram showing AI ML processing of sensor data using training data in an embodiment of the present invention.

FIG. 7 illustrates exemplars for primary field image manual identification, comparison and labeling of insect pestilence in accordance with an embodiment of the invention.

FIG. 8 illustrates sticky trap physical logistics and collection in accordance with an embodiment of the invention.

FIG. 9 illustrates plant disease templates used for non-expert manual identification aids, comparison and labeling of plant disease pestilence in accordance with an embodiment of the invention.

FIG. 10 illustrates templates useful for manual identification, comparison and labeling of insect pestilence and their associated symptoms in accordance with an embodiment of the invention.

### DETAILED DESCRIPTION

Specific embodiments of the invention will now be described in detail with reference to the accompanying figures.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTIVES AND ADVANTAGES

The present invention is a system and method of improving crop inspection from manual to automated adaptive machine learning responsive phase.

It is an object of the invention to create less labor intensive ways to discover and automate timely non-manual discovery of pestilence or other harms threatening a crop and where, so that with an early warning the cultivator/grower or farmer can protect against the threat before damage escalates to beyond easy, inexpensive or environmentally harsh solutions.

It is yet another objective of the invention to integrate sticky traps with electronic devices that can capture, report and send alerts, so that crops can inspected remotely and eventually analyzed by machine intelligence independently, continuously and pro-actively.

It is an object of the invention to automate inspection via wireless network integrated sensor sticky trap device such that sensor data can be inspected remotely and analyzed for threats by machine for a timely warning.

It is another object of the invention to obtain image data from remotely deployed sensors collecting data for use to train machine learning programs for monitoring plants and fields.

It is yet another object of the invention to obtain crop images from wireless network sensors with connectivity remotely but known locations, for labeled sorting and collection of crop threat categories applicable for labeled supervised machine learning training data.

It is an object of the invention develop affordable ways to obtain agricultural AI training data.

It is an objective of the invention to obtain pestilence and crop disease data for supervised, semi-supervised or Active Learning training data of machine learning AI programs monitoring crops

It is another object of the invention to democratize data, so that the data creator/owner is also the benefited, enabling farmers to leverage AI technology in operating their farms and businesses without requiring billions to purchase training data.

It is yet another object of the invention to create at next generation sticky trap to be used in combination with visual plant inspections.

### Figure Details

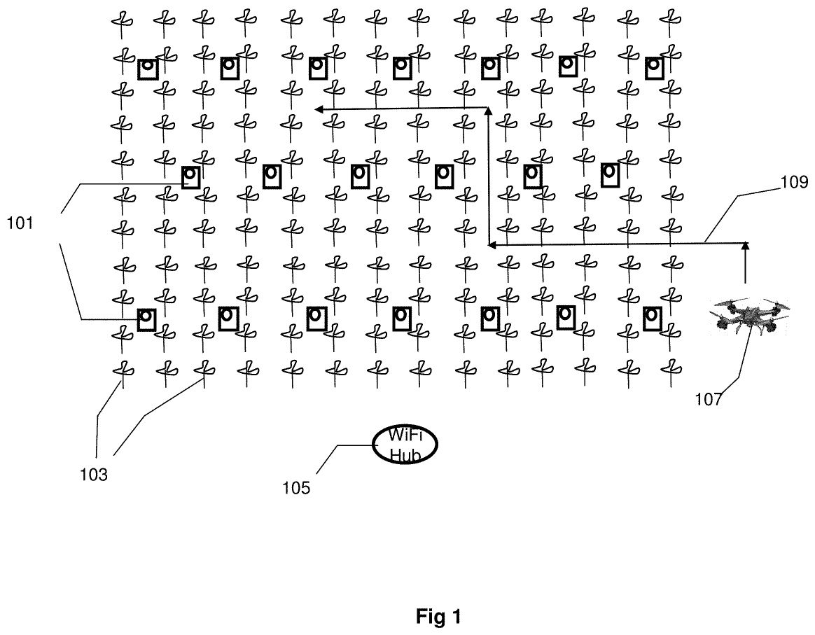

FIG. 1 is a high level block diagram illustrating sensor placement in an embodiment of the invention. The placement of sensors needed depends on many factors, including the main target pest sought for monitoring plants 103. Absent other guidelines a minimum of one sticky trap sensor 101 for every 10,000 square feet of growing area can be used. Since inspection is automated through wireless sensor networks and variable, image data taken with frequency required. Monitoring insects on integrated sensors can also be done programmatically from remote sensors 101 with wireless networks sending image data to a wireless network hub 105. Alternatively, government pestilence watcher programs set up to inspect for specific and particularly proven harmful pests will have a completely different geographic placement of sensors with wireless network hubs perhaps situated in citizen's homes, and not necessarily for food production. Based on the jurisdiction boundaries, residential plants and trees in need of protection with early warning alerts, state and local governments and associations can set up wireless network sensors with embodiments of the invention as well.

In indoor cultivation embodiments, placement of sensors are done differently. Some greenhouse pests are usually not caught on sticky traps. So the integrated sensor sticky trap placement must account. For these situations, sticky traps must be used in combination with plant images to confirm the presence of pest populations. Sensors may be placed at lower plant levels and extended as the plants grow. Placement of sensors 101 varies on the cultivation model employed. State, local, county governments, or agriculture associations may wish to employ integrated sticky trap sensors in various specific locations where specific plants 103 reside in their jurisdiction. The care and maintenance of the sensor sticky traps 101 becomes much less manual labor intensive, wider spread, as the image data is wired direct to servers and data viewers.

Another challenge of sensor placement is maintenance, communication and power. Where power is self generated from sensor local renewable energy/power, that is not insurmountable. But integrated sensors will require maintenance, acceptable wireless communication ranges and even trap cleaning. In these models a moving sensor an or moving WiFi hub 107 embodiment can be employed in the form of a sensor data gathering programmable flight pattern drone 107. Cameras are standard issue with drones, and many can be programmed with way points to fly a given pattern 109. Images with sufficient proximity to crop details are collected primary data via its onboard optical sensors, negating the need for having stationary placed sensors. Alternatively in some embodiments where wireless communication ranges are or bandwidth stretched or exceeded, drones are programmed to retrieve the stored sensor 101 data for download to a server after a batch collection from stationary sensors 101. Direct collection of sensor data from mobile sensors is less expensive on the actual number of sensors needed but may not have the image resolution required without more expensive optical sensors and smarter drone features. Also in some cases the optics and image traces may require a long or broad view of the crop for any sensor images containing the warning labeled characteristics. In most cases a plurality of integrated sensors network wirelessly collecting plant and insect primary sensor data in agricultural or community settings having crops will have the logic needed for primary sensor data transfer with associated sensor metadata onto a database for further analysis.

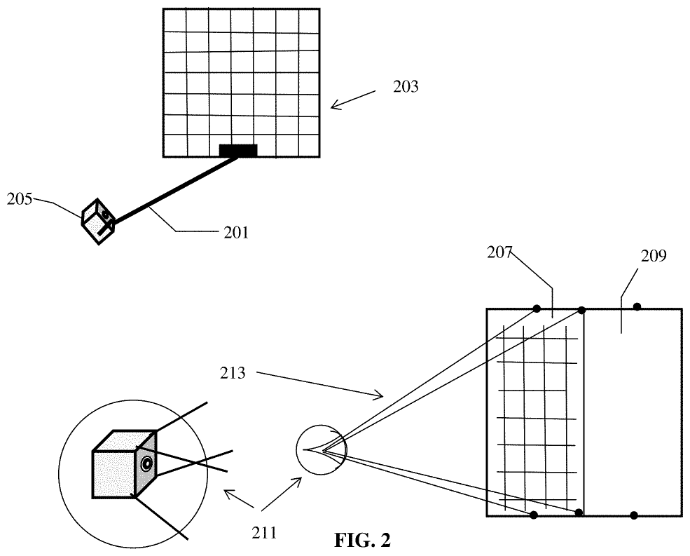

FIG. 2 illustrates a integrated sticky trap sensor in an embodiment of the invention.

Many types of sensors that can be used to create AI training data embodiments. In a simple embodiment of the invention a very small camera optical sensor coupled to wireless logic components 205 for wireless data transport is suspended from a sticky trap 203. Various optical sensors or lenses can be used to advantage overlooking the sticky trap, which is itself then hung or attached on the crop or plant to be monitored. In an embodiment the optical sensor 205 is suspended from a sticky trap 203 by one or more semi-rigid bendable stem 201 wire, thin plastic or composite attachments. The power of any lens is in its design and the focal length, so in order to collect the requisite image, a fish eye, wide angle or telephoto lens be used with focal length adjusted to the sticky trap. Image data can be obtained from other sensors as well including multispectral, acoustic, vibration, IR, thermal, etc.

Focus and magnification image data from weatherized sensors 211 may have optical sensor positioned views mapping the trap 207 view area, with sensor positioned by bendable adjustable stays 213 attached to the sticky trap 207. Placement of sensor traps is optimal for identifying characteristics of insect/bug/pest trapped on sticky traps 207 view as well as plant or foliage view area 209. The optical sensors 211 placement provides a way to capture image data with view an integrated sticky card 207 with and area having foliage or plant 209 view area adjacent. Imaging both sticky area and crop areas increases the integrated sticky sensor's capability in delivering more comprehensive image data for later processing. Wire, fiber or twisted filament material can be used for the stays 213 providing a sensor position having the requisite view area 209 of the plant as well as the insects.

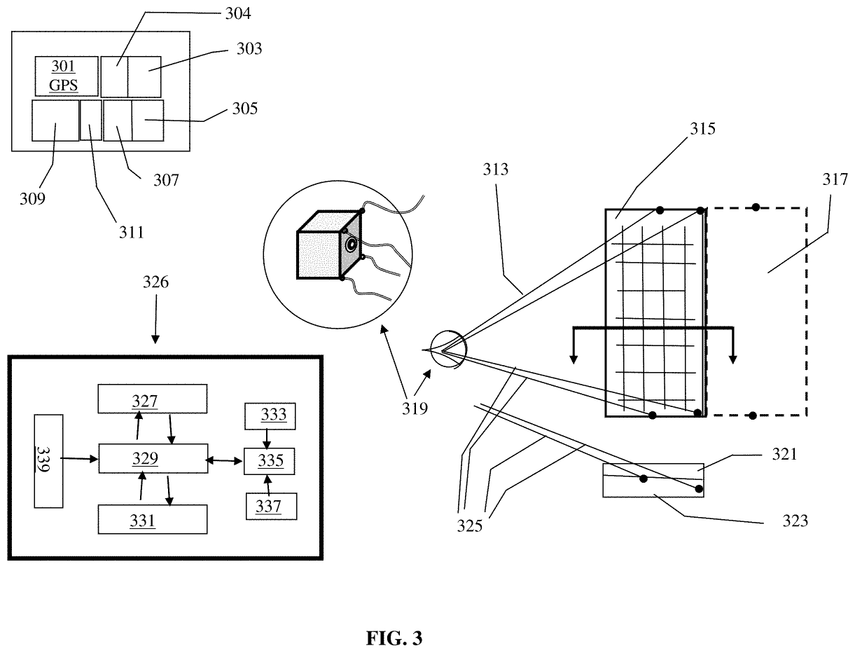

FIG. 3 illustrates the components and logic in sticky trap sensor in an embodiment of the invention.

Various optical sensors 319 can be used, including fisheye, telephoto, wide-angle or multispectral imaging. Image data can also be obtained from other than visible frequency sensors with multispectral, acoustic, IR, thermal, and other frequencies, humidity, location, light, motion and audio providing identifiable characteristics, symptoms and combinations of known plant disease or infestations. Audio sensors can have integrated filters and signal threshold logic in embodiments searching for any identifiable sound or vibration character identifying a particular pest.

Integrated sensors 314 couple a variety of electronic and photonic components including optical sensor 311 with logic and electronic components such as motion sensor 309, acoustic/vibration sensor 307, WiFi 305, GPS 301, accelerometer 304, memory, cpu and electrical power 303.

Since changing out battery power is impractical, relying on humans and logistics to regularly change batteries, an embodiment of the invention will use fast wireless power recharging, solar, wind or other external sources to power the integrated sensors. In an embodiment of the invention the battery or power can be rechargeable or even fast charging supercapacitor power and temporary storage with all of the necessary logic for conversion to storage from outside wireless power, external power sources or solar cell 323.

In some embodiments, a mote 326, having additional logic for performing some image processing, for collecting data and communicating with other connected nodes in the network is included. Logic and protocols to set timing to take data, preceding and following a dormant sensor power conserving mode is included in yet other embodiments. That is integrated sensors will have power off and on logic minimizing sensor power for use in intermittent data collection and transmission functions.

Optical sensors, sensors and motes can be very simple or complex, depending on the crop pestilence for which they designed to obtain image data from and monitor. In an embodiment of the invention a more complex sensor will have a transceiver 327 coupled to a micro-controller 329, coupled to external memory 331 for a small database of collected sensor data, micro-controller 329 coupled to power 339 and ADC 335, which is itself coupled to the sensors 333 and 337, optical and/or other types of sensors. In another embodiment the processors and memory will have logic for obtaining digital differences from stored sequential images onboard, the digital differences exceeding a set byte count triggers notice of new data for an upload request integrated sensors having logic for obtaining digital differences from stored sequential images onboard, the digital differences exceeding a set byte count triggers notice of new data for an upload request.

In another embodiment the integrated sensors have logic with sufficient memory to and cpu to store more than one primary sensor image, perhaps a small dbms and logic from downloaded and installed specific threat label trained AI analytic for identifying specific known and trained for threat objects in sensed image artifacts or objects or stored sensed image data onboard the integrated sensor, sending notification of the found matches to the hub.

It is conceivable that a build up of trapped insect showing up over a time period on the traps and on the images, making it more difficult to distinguish individual insects. Where the insect information is not alarming, and alerting candidate insects can potentially show up in traps too crowded to distinguish them, in some embodiments successive sensor image transmission redundancies can encoded out, ie only the differences encoded into a sensor upload transmission, such that only the newly arrived insects or trapped bugs are reported by the sensors. Furthermore compression, such as the Discrete Cosine Transform used in MPEG and JPEG formats, techniques embedded in sensors can be used where sensor image transmission bandwidths are limited.

A flat sticky trap 315 base is coupled to an integrated sensor 319 or mote 326 via bendable wire 313, thin plastic or fiber support(s) stays from the base 323 of the sticky trap and suspending the sensor to a desired view position. The base 323 can include solar cell substrate for power for the integrated sensor 319 vi conductor 325 or support stays 313. This base 323 has a layer of transparent or clear sticky layer coat 321 covering the base 323 surface. The solar cell 323 substrate surface substantially layered with transparent sticky 321 substance for encroaching insect adhesion, with the solar cell providing power to the extended sensor 319. The optical sensor 319 will be positioned to have a focus on the insect trap area 315 and a plant/crop area 317 for delivering image data.

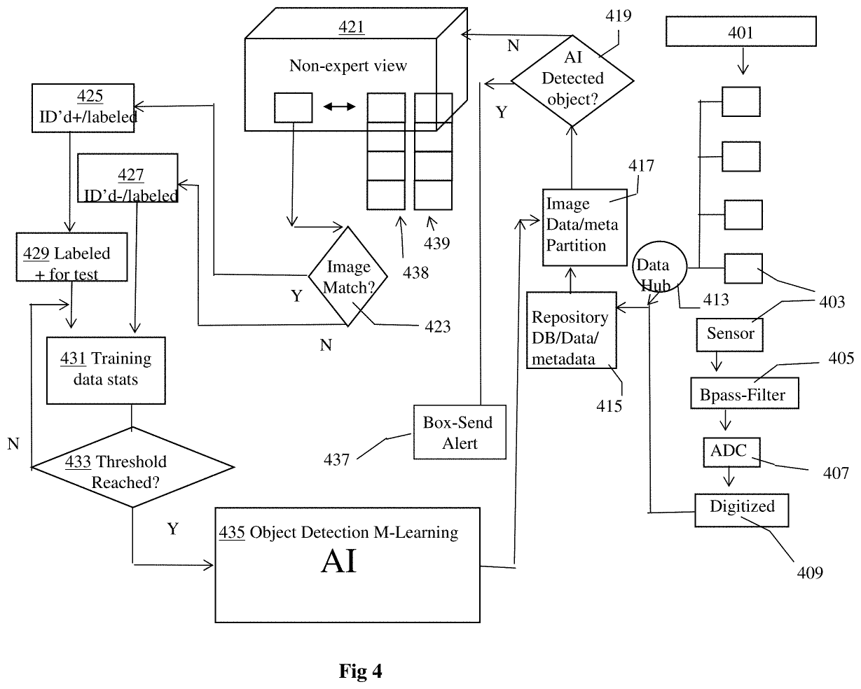

FIG. 4 is a high level flow diagram showing system architecture developing training data in accordance with an embodiment of the present invention.

In an embodiment of the invention, a wireless sensor network 401 having low-power integrated circuits, and wireless communication is at the heart of a wireless sensor network 401, with sensor 403 monitoring with real-time or programmed delay updates of data through the network. Intelligent plant sensors are integrated into a wireless sensor network for early detection of plant or crop conditions. Plant growth and plant disease or damage rates do not generally impair normal processing activities. The sensor information is transmitted wirelessly to an external processing unit at program set or programmed delay rates, ostensibly in application of power saving strategies. Data from acoustic or vibration sensors 403 are collected similarly where data can become graphical or image data. Image data acquired from integrated sensor data remains digitally linked with associated metadata containing at least sensor data time, location, date and type of plant monitored.

For example, for embodiments wherein the integrated sensors have Internet connectivity, logic to transmit data from an integrated sensor or mote 401 to a network database 415 from Python issue command:
accessor.put_json(Your_db_url, database_uri, [Samples], data=samples)

Integrated sensor logic for command issued to receive information back sequentially:
code, prefix=accessor.next(Your_db_url, database_uri, prefix)

In an embodiment of the invention logic must ‘import’ the Your_db accessor module called ‘Your_db.access’, which is an additional line at the top above, ‘Your_db_url’ is the URL for the Your_db cloud server, to use, and the ‘database_uri’ is the identification in that cloud server of the database to use, and ‘prefix’ is the location within that database of the data.

Acoustic, vibration and other type sensor data 403 can apply bandpass, threshold and other filters 405 to isolate potential actionable data for particular pests, convert by ADC 407, digitize 409 and frame data for transmission to a sensor hub 413 for forwarding and synchronization with meta data before transmission to an image/data/metadata database 415. The sensors can generally have multiple site locations as well as multiple human monitors which will in short period of time develop stored data. All the data and metadata captured at this point is potentially valuable for a machine learning AI in future data mining use regardless of what is found upstream. This data can be stored, in the cloud or other space, for future sale or use above and beyond the current accumulation of training data and crop monitoring.

The forwarded image data or local server 417 stored image data 415 are partitioned, separating the bug images views from the plant image view data, forming at least two main data image streams. Where there is no bug image part or plant image part, then partitioning is cropping existing other part The image data is programmatically tagged with available surrounding or associated data and metadata available from the sensors as well as server programmable information such as:
date, time, location,
environmental conditions,
temperature, humidity, water,
region, season, climate cycle time,
crop known pest infesters, larvae images,
biofix or mating initiation cycle/activities,
associated pest mating activity parameters,
etc,

and other associated parameters to a database 415 that will be useful in AI machine analytics and or useful label corroborating symptoms as found by non-domain experts using exemplars. The image data will have potentially bug pest view area and plant view area. These are partitioned to pestilence and plant views before visibly demarking bounding boxing specific or particular objects in the image data. Non-domain experts viewing objects partitioned images and identifying a pest or plant pestilence with good certainty 419 bounding box label the object and signal an alert 437 to the handler authority warning them of the possible intrusion. In addition, notice can be pushed to an outside repository inquires regarding the pest positively identified along with it associated data and meta data can be made available to other entities, agencies and jurisdictions

It is not inconceivable that crop/plant images have bug pestilence or bug pestilence images containing plant artifacts from surrounding overgrowth. An embodiment of the invention for image partitioning 417 will be primarily based on the sensor areas in the primary sensor images viewed. ie bug pests found in the partitioned plant image areas are still box bounded by non-experts for object identification in the same way that they are bounded by boxes for object identification in the way that they are bounded by boxes for object identification in the partitioned sticky trap bug pest image area. In visual searching for suspect bug image candidates, if there is nothing immediately identifiable, the non-expert 421 can obtain assistance from inside and outside sources, accessed via db search or data menu of bug and plant disease exemplar images 438 with associated symptom data. Assistance can come from Internet services, libraries, or system owners.

These labeled exemplars can come from a variety of sources but generally for well known infesters, from undisputed as to authenticity and adequacy of image representation, label, and symptom representation of the suspect threat bug/pestilence. Authority of exemplars can also come from owners seeking to keep out a particular growth, as farmers near a patented GMO crop. Farmers and growers may wish to warn against a neighboring crop seeding on their crop boundary. A warning against this onset would be enacted by exemplars for the non-experts to look for in the images. To further aid the viewing non-domain expert 421 for more reliable positive identifications, an embodiment of the invention provides bug pestilence exemplar(s) or plant threat exemplars and associated symptom data for these which be linked or associated with the plant damage or plant identifiable object representation of the bug pestilence. Demarked and labeled object non-expert identified positively matching exemplar grouped with positive labeled image set 425 or non-matching image data grouped with negative image data set 427 if not matching.

In other words, if the viewer sees what maybe a Glossy Winged Sharp Shooter but is not very certain, they can seek for verification from GWSS eggs, larva or plant damage, environmental factors etc. to help up the likelihood in ascertaining a positive or negative disposition for the suspect candidate.

The crop image monitors, generally non-experts, must determine the type of training examples that are sought and they would need tools to aid them in finding likely exemplars. They can search on the crop associated pestilence from past experience data. The crop destructive pests are generally known and they can be listed on a “wanted” list of potential threats. When a crop anomaly is first suspected as a candidate for a pestilence or plant damage, exemplars 438 lists are made available to the human non-expert plant monitors to peruse through for comparison purposes and cataloging purposes. The exemplars 438 would be of qualities that clearly display and label the pestilence or plant damage of interest to be identified and classified. Each exemplar may be offered in one or several images with clearly demarked features individually measurable or characteristic identified for the pestilence or plant damage candidate. Resources for Database of Insects and their Food Plants image exemplars can be found on public sources such as Universities, state governments, county governments, and agri-business associations as well, concerned with the public interest and dissemination of possible crop infestations. Furthermore exemplars themselves would be identified or confirmed by human domain experts who clearly identify and demark the features sought for each pestilence or plant damage training data set 425 427.

Alternatively, outside sources, resources or Internet service models can be used. To aid them in finding positive images the positive image training data of pests sought that appear familiar as possible positive data, non-expert monitors can also turn to posting requests known as Human Intelligence Tasks, HITs, on crowd sourcing marketplaces 439 like Amazon Turk. The monitors can request identification of suspect images from “Workers” also known as, as Turkers, who browse among existing jobs and complete them in exchange for a small monetary payment set by the employer or in this case the monitor seeking assistance. To place request, the non-expert requesting programs use an open API, or the more limited MTurk Requester site, submitting a request for tasks to be completed through the Amazon Mechanical Turk web site by providing the image identification task and a billing address for satisfactory work compensation.

After non-expert adjudication and possible comparison with known crop pestilences exemplars a decision 423 will send the affirmative candidate data positive assessment to positive identified and labeled data repository 425 and negative candidate data to a negative identified label as such to a negative associated data repository 427. Thereby each training set will have a positive 425 and negative 427 subset of images. In addition a test set 429 of data will also be collected for validating the once trained AI program. The positive labeled images 425 for testing 429 will come from images or data that have been identified by the non-experts as leaving the features sought as shown in the exemplars. These repositories store images received are necessary for training data set accumulation for minimum AI training data requirements.

As above, a set percentage of the positive identified and labeled data validation or test data 429 will be saved off for later qualifying the trained AI program. As the data is collected, they are counted against a set goal number 431 of minimum required data sets. This is a preset minimum numerical count for threshold of training image data for a specified label of positive and negative data image set counts and can be established by machine learning experts knowledgeable or by trial and error as to the numbers required for acceptable error rate AI analytic programs trained from the training data. The test set 429 are positively identified labeled data to be used for validation after the AI learning program has been trained.

A training set positive, negative and test minimum required for adequate training set numbers 431 are obtained from ML experts for gathering a sufficient number of labeled member image data for each particular exemplar category sought. This can also be described as collected training set number of images to be submitted by the non-experts 421 to be labeled and representative of what would be expected to be found in the sensor placed setting, as above in the exemplar images identified/classified by domain experts.

The requisite number of positive and negative images falling between the low and high input set numbers for a particular pest or plant damage is made for the positive and negative subset in order for a complete training set. Thus, a set of input images or data objects can be gathered across two or more non-experts and with corresponding consistent outputs from the sensor output images or measurements.

Once the threshold labeled data set requirements are reached 433 the data sets are saved to the AI analytic program directories from which the AI machine learning program will take the training data in its training phase. Logic responsive to specified label set image count thresholds, will forward accumulated data sets reaching threshold specific image label count as input training data to an AI machine learning program for creating an AI analytic capable of identifying the specific labeled image object in primary sensor data images. Upon reaching the requisite critical mass of image data, negative and positive for an expert trained AI level, with supervised or semi-supervised training image data is fed to an AI machine learning program 435 for training.

The training data 433 is placement is in accordance with an AI program's input requirements and the AI machine learning program can then apply any of the algorithms which will then create a program capable of detecting the labeled specific object in an image candidate submitted after training. Upon successful training and testing the trained AI program is then applied to primary sensor image collected and partitioned 417 for a totally automated identification of pests in the wirelessly assembled sensor images and data. Thus a trained executing AI analytic will scan the plurality wireless sensor data images for pestilence and plant objects matching positive trained identified labeled objects with logic responsive to monitoring for positive identified labeled objects raising alerts for positive label trained objects identified in sensor data images.

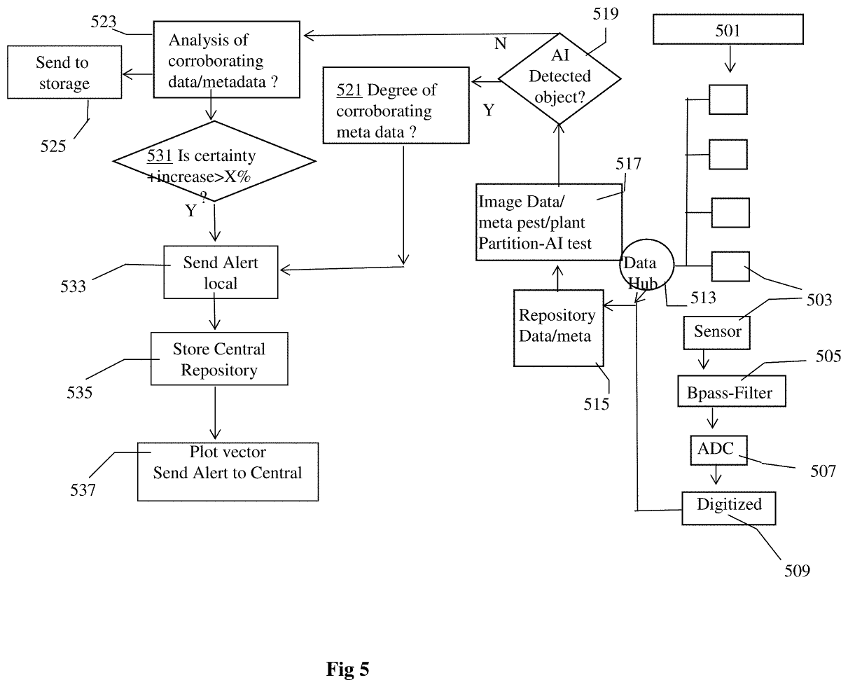

FIG. 5 is a high level flow diagram showing an adapted system architecture using a trained AI programs with image and meta data in accordance with an embodiment of the present invention.

As with other embodiments, metadata is an important aspect to monitoring plants or crops for training data. Once a sought or triggering object is identified, a warning is meaningless unless the time and location of the sighting is also known. In embodiments of the invention the metadata, time, location, environmental readings with the images, crop/plant type, spectral parameters or image type and more, are used to alert the non-expert in identifying situations and circumstances whereby possible threat existence from such information can increase focus and alert for finding actual threat objects and with higher certainty.

In an embodiment of the invention, a wireless sensor network 501 having low-power integrated circuits, and wireless communication is at the heart of a wireless sensor network 501, with sensor 503 monitoring in real-time or programmed delay updates of integrated sensed data and transmission through a wireless network. Intelligent plant sensors are integrated into a wireless sensor network for early detection of plant or crop conditions. Plant growth and plant disease or damage rates do not generally impair normal processing activities. The sensor information is transmitted wirelessly to an external processing unit at program set or programmed delay rates, ostensibly in application of power saving strategies. Data from acoustic or vibration sensors 503 are collected similarly where data can become graphical and then image data.

As in the above example, logic to transmit data from an intelligent mote sensor 501 to a DB 515 from Python issue the command:
accessor.put_json(Your_db_url, database_uri, [Samples], data=samples)

To receive information back sequentially, sensor logic would issue the command:
code, prefix=accessor.next(Your_db_url, database_uri, prefix)

In an embodiment of the invention logic must ‘import’ the Your_db accessor module called ‘Your_db.access’, which is an additional line at the top bove, ‘Your_db_url’ is the URL for the Your_db cloud server, to use, and the ‘database_uri’ is the identification in that cloud server of the database to use, and ‘prefix’ is the location within that database of the data.

Acoustic, vibration and other type sensor data 503 can apply bandpass, threshold and other filters 505 to isolate potential actionable data for particular pests, knowing their specific identifiable attributes from examplar data, convert by ADC 507, digitize 509 and frame data for transmission to a sensor hub 513 for processing or synchronization with meta data before transmission to an image/data/metadata repository 515. Thus adapting a trained executing AI analytic will scan the plurality wireless sensor data images for pestilence and plant objects matching positive trained identified labeled objects with logic responsive to monitoring for positive identified labeled objects raising alerts for positive label trained objects identified in sensor data images and timely raise alerts of found labeled positively identified insects or plant harm without human visual intervention, alerts retaining sensor meta data, time and location of sensor data triggering image alert.

In yet another embodiment, the integrated sensors 501 will have sufficient memory and cpu logic to store more than one primary sensor image with cpu and logic to trigger on image artifacts or objects sought by a downloaded and installed trained AI analytic. In such cases, a downloaded and install to sensor 501 of trained analytic will process the sensed image data for specific known and trained for threats directly onboard the sensor, sending notification of the found matches to the hub 513 and onto the server image database 517. In an embodiment, alternate sensor data send requests from sensors can be triggered simply from sensor logic obtaining digital differences from stored sequential images onboard the integrated sensor 503, where the digital differences of a given significance will trigger notice of new data and hence an upload request. Thus where sensor upload bandwidth is limited or periodic, as with a data collecting drones, added storage capability onboard the integrated sensors allows more optimal data transmission times for compliance with lower transmission bandwidth capacity.

The cloud forwarded image data or local server 517 stored image data 515 are partitioned, separating the bug images views from the plant image view data, forming at least two main data image streams. The image data is tagged with associated data and metadata available such as date, time, location, environmental conditions—eg temperature, humidity, water, crop type, etc, and in short any associated parameters that can later be used in machine analytics and or useful pest corroborating symptoms by non-domain experts. The image data will have bug pest view area and plant view area. Trained AI analytics for identifying specific image objects as pest or plant pestilence with a set degree of certainty 519 will label the object and signal an alert 533 to the local monitor warning them of the possible intrusion, providing the object identified and associated meta data and confirming data from any associations.

In an embodiment, any negative object identification 519 will commence scanning and analysis of any associated image data, meta data 523 by any corroborating factors from analytical techniques such as normalized canonical discriminant analysis, nCDA, principal component analysis, PCA, Partial least square discriminant analysis, PLS-DA and others. These may use what is known about the environment, pestilence, any sought for object common symptoms such as common environmental variables, type of crops/plants known to infest, geography, geographic area type, temperature preferences, humidity or moister, soil, water, etc.

In some embodiments of the invention multispectral imaging can provide data for symptom discrimination and identification of crop diseases and pestilence including visual and non-visible spectral frequencies. As above embodiments, exemplar image data can be used to facilitate image inspection and labeling by non-experts. Downstream, various techniques such as normalized canonical discriminant analysis, nCDA, and principal component analysis, PCA, can be used to analyze the data and compare the image results as well.

In some embodiments other than visible image data can reveal clear identifiable distinctions between the healthy and the inflicted crops. nCDA can also be used for pairwise discrimination from symptoms images without experts. Partial least square discriminant analysis, PLS-DA, can also be used to classify more closely perceived alike symptoms to increase classification accuracy for better training data. These can also be used in combinations where stepwise PLS-DA models had satisfactory classification errors for cross-validation and prediction. The results from multispectral imaging data can become training data of plant harms and health character. Even negative or data not showing immediate threats or valuable for immediate label training data can be stored and mined later for less direct causal variables and valuable correlations, and so is then stored 525.

Any common associations can be used to increase the certainty of a discovered threat by non-experts initially for training data to above a set level threshold 531 which will prompt an early warning alert 533 as well. Alerts and data are stored in cloud 535 for further processing to larger scale community notification 537 capable and responsible for tracking larger geographical threat vectors.

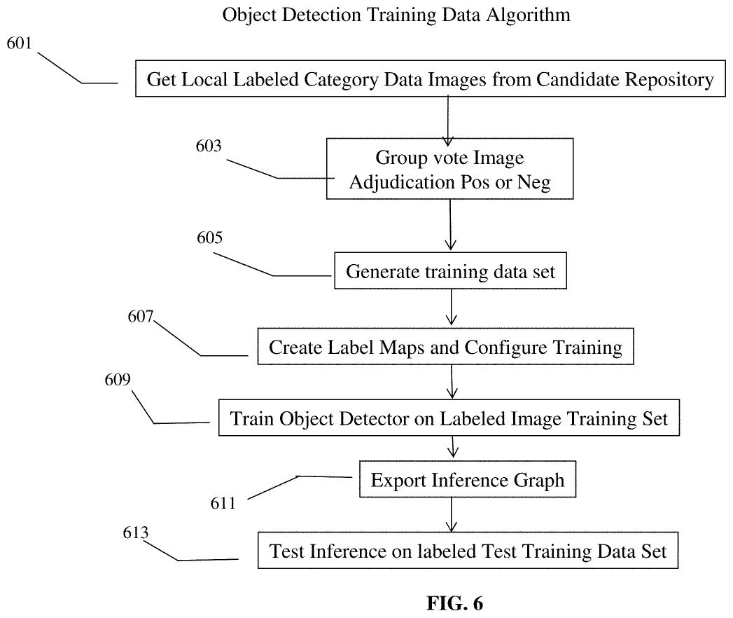

FIG. 6 is a flow diagram showing AI ML processing of sensor image data using training process in an embodiment of the present invention.

In machine learning, algorithms work by making sensor image data-driven predictions or decisions through building a mathematical model from the input input training data. In an embodiment of the invention the data used to build the final program will come from multiple datasets of algorithm sufficient number of images. As mentioned for above embodiments in particular, three data sets of images are commonly used in different stages of the creation of a model.

Furthermore, an ML knowledgeable individual upon scanning a specific exemplar for features and some candidate training input data will determine the structure of the learned function and corresponding learning algorithm. For example, the selection may algorithm may be support vector machines or decision trees. Learning algorithm selection can address bias-variance tradeoff, function complexity and amount of training data, dimensionality of the input space, noise in the output values and other factors.

Many Object Detection Classifier algorithms are available to train AIs from training data input. These are installed for executed using the training data sets provided. There are pre-trained object detection models available as well. These or others are used train on embodiments of the invention training data.

Training data files must be configured and made compatible to the AI program input specs in size and format. There are training data, positive and negative sets, and test data image sets. There are also image labeling programs to help prepare the training data image sets Where there are more than one image of interest in a single data image, multiple labeled images can be saved in independent files for training from a single data image. A preliminary step in the AI process is to create a label map, mapping class names to class ids, and configuring the training data for the object classifier. Once all of the training data labeled, mapped and classified we can train the object detector.

A particular model is initially fit on a training dataset, for supervised data training labeling which is a set of examples used to fit the weights of connections between neurons in artificial neural networks, ANN, of the model. A model is trained on the training dataset using a supervised learning method, for example a gradient descent or stochastic gradient descent method.

The training dataset consists of pairs of an input vector and the corresponding answer vector or scalar, which is commonly denoted as the target. An embodiment of the invention will execute the training dataset and produces a result, which is then compared with the validation set, for each input vector in the training dataset. Based on the result of the comparison and the specific learning algorithm being used, the parameters of the model can be adjusted. The model fitting can include both variable selection and parameter estimation.

Successively, a fitted model is used to predict the responses for the observations in a second dataset called the validation dataset. The validation dataset provides an unbiased evaluation of a model fit on the training dataset while tuning any of the model's hidden units in a neural network. Validation datasets can be used for regularzation, the introduction of additional information in order to solve an ill-posed problem or to prevent over-fitting by early stopping: ie. Cessation of training when the error on the validation dataset increases instead of decreases, as this is another sign of over-fitting to the training dataset. This simple procedure is complicated in practice by the fact that the validation dataset's error may fluctuate during training, producing multiple local minima. This complication leads to creation of ad-hoc rules for deciding when over-fitting has truly begun.

Finally, a test or validation dataset is a dataset used to provide an unbiased evaluation of a final model fit on the training dataset. The test dataset can be randomly selected fraction with the highest likelihood of the positive identified and labeled image dataset. Some supervised learning algorithms require the user to determine certain AI program control parameters which may be adjusted by optimizing performance on a subset, validation set, of the training set, or via cross-validation

To create a Classifier or Object Detector, analytic that can detect multiple labeled objects in an image, and paint multiple bounding boxes, the following object detection training application is implemented in popular supervised AI machine learning applications and used here as an aspect of the invention.

First, get the local category data images from the candidate repository 601. A complete data image set contains properly cropped images in the system environment expected. Next the images should be label assured to be in the positive or negative sets properly placed 603. Next, generate an AP program ready training data set 605 making sure that all labeled objects in the image are boxed or box bounded. Next, convert all pixels to XML or CSV format and create label maps and configure data 607. Next convert class names to ID # and execute train object detector on labeled image training set 609. The trainer can use any of the typical AI machine learning implemented algorithms for identifying image objects including Dimensionality reduction, Ensemble learning, Meta learning, Reinforcement learning, Supervised learning, Unsupervised learning, Semi-supervised learning, and Deep learning. Next, Export inference graph 611, copy the image sets to the training directory and the text directory.

Lastly, test the inference on the test or validating data set 613. Over fitting/overtraining in supervised learning is determined as follows. Training error is graphed against validation error, both as a function of the number of training cycles. If the validation error increases, positive slope, while the training error steadily decreases, negative slope, then a situation of over fitting may have occurred. The best predictive and fitted model would be where the validation error has its global minimum.

Any machine learning methods including but not limited to Dimensionality reduction, Ensemble learning, Meta learning, Reinforcement learning, Supervised learning, Unsupervised learning, Semi-supervised learning, Deep learning, and other machine learning methods can be used where applicable to a candidate pest or plant harm object identification.

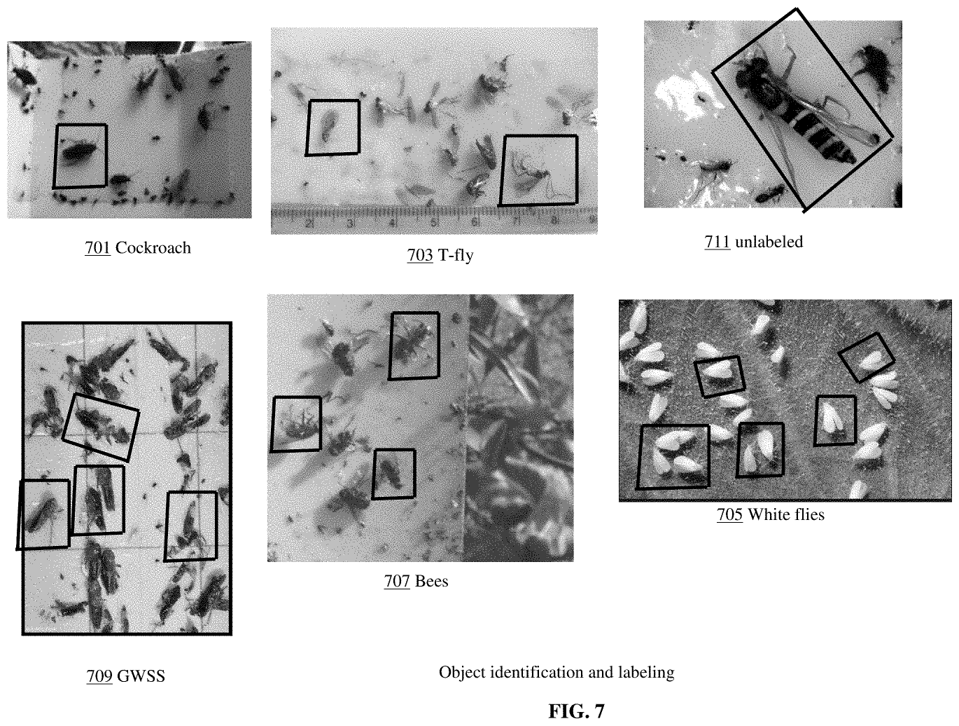

FIG. 7 illustrates exemplars for primary field image manual identification, comparison and labeling of insect pestilence in accordance with an embodiment of the invention.

As mentioned above, visual comparison of partitioned and cropped data with template images of specific pestilence and plant disease/threats respectively, for the step of primary candidate object identification and labeling is available to viewers of the primary sensor data images in ascertaining candidacy for labeling in a particular category.

The exemplars cockroach 701, Tse-tse fly 703, white fly 705, bees 707, glossy winged sharp shooter 709 are all box bound and labeled exemplars obtained from available public sources. 711 is a boxed but unlabeled example with serves as insufficient and not applicable for this step of the process. Alternatively, farmers or crop owners may also wish to train their AI analytics to warn them of weeds or other farm conditions which should alert them to take some action. Thus farmers may obtain images of rows with an overabundance of weeds, or even a lesser quantity of weeds which bourderline should trigger the farmer's process to eliminate the weeds at this opportune time, before the weeds grow out of control and become an expensive problem. The non-expert is given these exemplars of rows or furrows of the weed densities which with a trained data set AI analytic will alert the farmer precisely when it is time to hand weed, mulch, livestock graze, flame, heat or other solution.

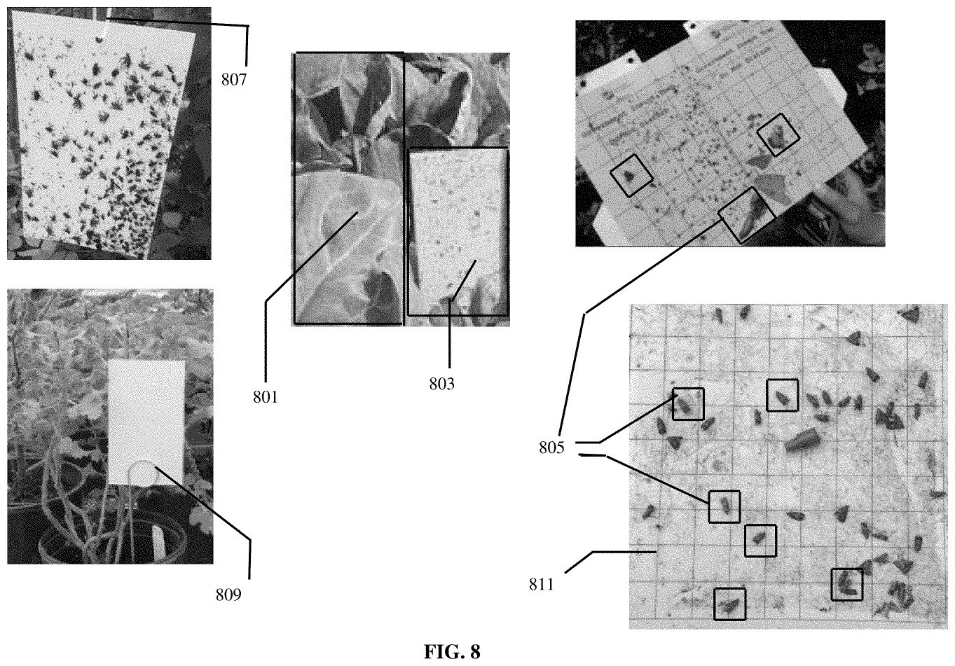

FIG. 8 illustrates sticky trap physical logistics and collection in accordance with an embodiment of the invention.

An integrated sticky trap sensor image is illustrated in partitions, the leaf partition 801 to the left of the bug partition on the right hand side of the image. Tools for view display comparison of exemplar images of specific identified insects and plant harms with non-expert demarked image data are provided. The primary images received from the integrated sensor sticky traps data streams can be done programmatically via computer vision routines or manually. A further inspection showing potential candidates are manually bounded by bounding boxes 805 for further analysis. Scale markers 811 can be used on the trap base to retain the pests dimensions. These are important because even non-experts given dimensions for notorious pests can more easily identify them or discount otherwise plausible candidates. The integrated sensors traps can be attached or affixed by any means, a top clip 807 or a stem clip 809 are typical but other attachment mechanisms are possible. In and embodiment of the invention logic for partitioning 801 the primary sensor image data into insect pestilent and plant images is provided along with tools for digitally bounding border 805 demarking an object in a partitioned data image

[symbol]

[symbol]

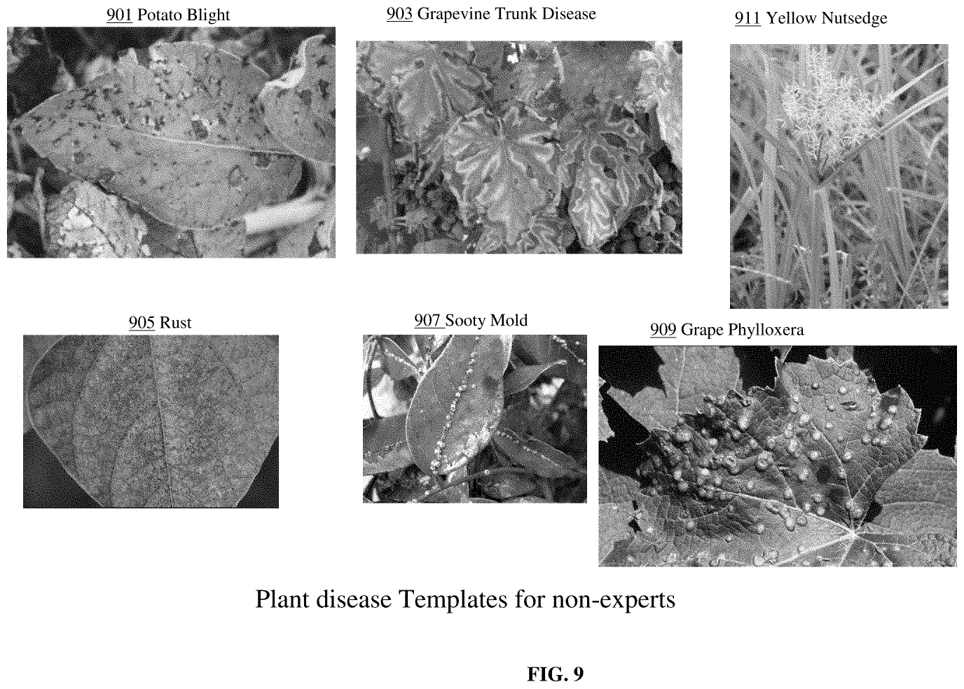

FIG. 9 illustrates plant disease templates used for non-professional manual identification, comparison and labeling of plant disease pestilence in accordance with an embodiment of the invention.

In many cases the pests leave plant evidence or symptoms, which can be caught on the plant stream of the images. This plant damage can come in the form of distinct characteristic discoloration, bacterial affects, dehydration, larvae and other visible and alternate spectra indicators. A good example is the GWSS, larvae left on the leaves and the plant dehydration and destruction artifacts. The point is, not visually finding the pest in the image data can still point to warnings and alerts to the presence, which can be indicated in more than one symptom.

### Common Documented Plant Diseases and Threats

There are many types of well documented diseases which can affect plants or crops. The symptoms are generally known by inspection. For example when plants suffer from blight, leaves or branches wither, stop growing, and die. Later, plant parts may rot. Fire Blight, Alternaria Blight (Early Blight), Phytophthora Blight. These are well documented and exemplar image data can be obtained and used by non-expert monitors looking at primary image data received from sensors.

Other disease include Bacterial Blight, Cankers: Cytospora Canker, Nectria Canker. Rots are diseases that decay roots, stems, wood, flowers, and fruit. Some diseases cause leaves to rot, but those symptoms tend to be described as leaf spots and blights. Rots can be soft and squishy or hard and dry to the feel. They are caused by various bacteria and fungi. Some are very active in stored fruits, roots, bulbs, or tubers. Fruit Rots, Root or Stem Rots, Mushroom Rot, Wood Rot. Then we have Rusts, Asparagus Rust, Wheat rust, cedar-apple rust, and white pine blister rust, Wilts, Stewart's Wilt, Fusarium and Verticillium, Wilt, Anthracnose, Club Root, Downy Mildew, Galls, Leaf Blisters and Curls, Leaf Spots, Blackspot, Molds, Powdery Mildew, Scabs, Smuts, Viruses, Nematodes.

Yet other symptoms of plant damage are common cultural disorders including Cold injury, Heat Injury, Moisture Imbalance, Wind Damage, Salt Damage, Ozone Damage. In and embodiment of the invention, examplar images of these can be made available to first viewer non-experts or monitors and crop caretakers on the watch for plant health. These then form the first line of defense for early warning, and accumulation of training data and then later a trained AI for any specific plant pestilence or damage.

Non-native grasses and broadleaf weeds are the bane of any native plant grower or farmer. Once these grasses or weeds take hold they are very difficult to eradicate. Many growers have bottom line rule to abstain from any type of pesticide, even supposedly safe ones. Also they are costly and even more so when the growth of the weed is “out of control”. So for this reason early warning automated approaches are essential. A sensor placed to view a row or plant furrow will supply images of any weeds, grass and unwanted growth. These can also provide non-expert labeled training data, and adaptively, a labor free monitoring system for any maintenance feature that needs attention, the earlier the better or at some particular growth stage. Here the data images will not be for any particular item, but an association of variables forming “too many” weeds or grass.

Some labeled exemplars shown are the potato blight 901, grapevine trunk disease 903, rust 905, sooty mold 907 and the infamous grape phylloxera 909.

Nutsedge is ranked among the worst weeds in the world. Certain varieties of nutsedge grow, thrive and infest fields everywhere. Farmers are told to be on the lookout for this incredibly invasive weed. Growers are warned, “If you don't have it, don't get it,” “It's a game changer.” One of the biggest hurdles of nutsedge is its early appearance. As it sprouts it looks like grass and can be easily overlooked as such. However, this is a plant of a completely different family and one that is far more prolific than the grass it can disguise itself as. To identify nutsedge, the farmer, non-expert, is admonished to look for a triangular or V-shaped stem and pointed V-shaped leaves in pale green. Labeled images on nutsedge abound. Early warning is key to problem prevention from this weed. One variety, Yellow Nutsedge, exemplar 911 is shown in FIG. 9 Growers collecting sufficient training data for their particular nutsedge will train and execute an AI analytic that will provide an automated sentinel warning on even the onset of nutsedge amongst their crop.

In an embodiment of the invention any farmer, owner or non-expert can collect images of these weeds and grasses for exemplars, and have sensor image data entered into the invention training data stream for identification of these invasive or alarming species. Upon collection of a critical mass of partitioned, boxed and labeled positive and negative images of the weed will be forwarded to the AI analytic for training an AI weed/non-native-grass analytic selected by system owner for an adaptive machine monitoring early warning system.

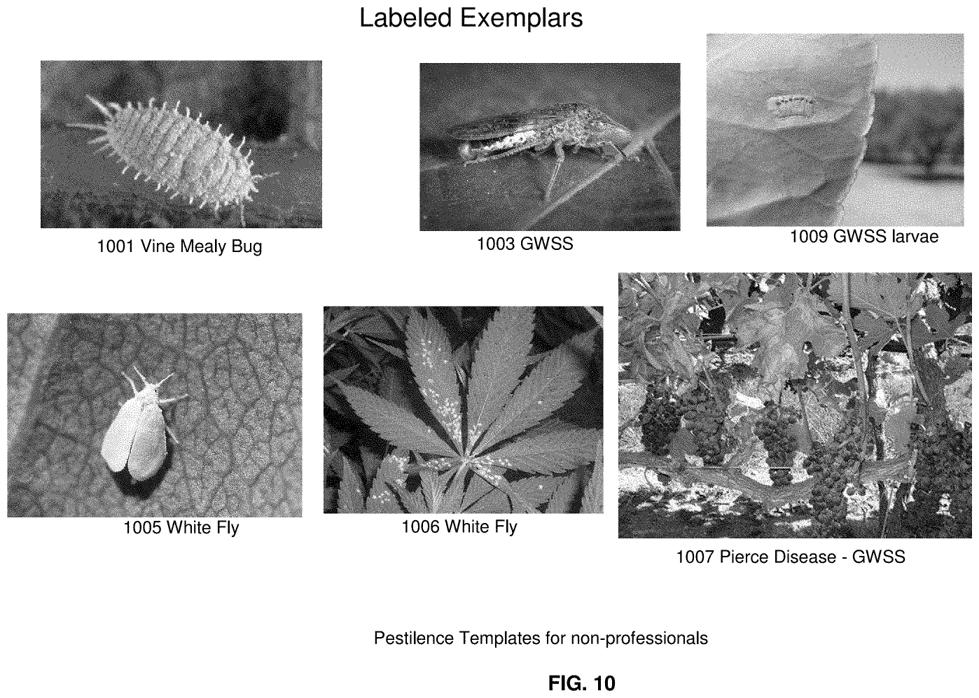

FIG. 10 illustrates exemplars useful for manual identification, comparison and labeling of insect pestilence in accordance with an embodiment of the invention.

Having available known suspect crop pests surrounding or associated data and metadata available from the sensors as well as existing information such as: date, time, location, environmental conditions, temperature, humidity, water, region, season, climate cycle time, crop known pest infesters, biofix or mating initiation cycle/activities, larvae images, associated pest mating activity parameters, etc, can help non-expert image monitors to identify, label and box identified objects in their sensor image stream. The non-experts will access lists of images of associations of the candidate or suspect as yet unconfirmed and labeled pest. Shown in the FIG. 10 is an exemplar of the Glassy Winged Sharp Shooter 1003, GWSS. Data associated with this pest is the GWSS larvae 1009 image as well as the GWSS disease imposed on the grape plant that GWSS infestations decimate, Pierce Disease 1007. This is where “guilt by association” is a practical approach for the non-expert identification of candidates for good training data. When the non-expert certainty is low, corroborating data or correlation can be used by the non-expert to increase the probability that the object observed is indeed the exemplar sought. Other sensor parameters matching the known associated characters from data can be linked to accessed and displayed to non-experts to aid them identifying and labeling the more difficult to identify images, hopefully before their numbers become a large threat. Likewise the sensor image of a white fly are small and difficult to compare with exemplar White Fly 1005, higher certainty can be achieved with confirmation from temporal or geographic proximity sensor plant image data of the associated plant damage exemplar 1006. Furthermore sensor placement can be use to help identify for example, where the pest candidate is a Vine Mealy Bug 1001, where the sensors can be positioned on the stem or even ground where they are more likely to be discovered by the optical sensors. Non-experts using associations or symptoms of a pestilence can identify and label objects from lower quality image data and correlation image data.

Therefore, while the invention has been described with respect to a limited number of embodiments, those skilled in the art, having benefit of this invention, will appreciate that other embodiments can be devised which do not depart from the scope of the invention as disclosed herein. Accordingly, the scope of the invention should be limited only by the attached claims. Other aspects of the invention will be apparent from the following description and the appended claims.

What is claimed is:

1. A system for adapting an in situ wireless sensor network monitoring system to AI analytic trained automated plant cultivation monitoring system, accumulating wireless sensor image data into identifiable labeled image objects for training AI analytics comprising:
a plurality of integrated sensors network wirelessly collecting plant and insect primary sensor data in agricultural or community settings having crops;
logic for primary sensor data transfer with associated sensor metadata onto a database;
logic for partitioning primary sensor image data into insect pestilent and plant images;
logic for non-expert digitally bounding border demarking an object in a partitioned data image;
logic for view display comparison of exemplar images of specific identified insects and plant harms with non-expert demarked image data;
demarked and labeled object non-expert identified positively matching exemplar grouped with positive labeled image set or non-matching image data grouped with negative image data set if not matching;
preset minimum numerical count for threshold of training image data for a specified label of positive and negative data image set counts;
logic responsive to specified label set image count thresholds, forwarding accumulated data sets reaching threshold specific image label count as input training data to an AI machine learning program for creating an AI analytic capable of identifying the specific labeled image object in primary sensor data images;
a trained executing AI analytic scanning a plurality wireless sensor data images for pestilence and plant objects matching positive trained identified labeled objects, and
logic responsive to monitoring for positive identified labeled objects raising alerts for positive label trained objects identified in sensor data images;
whereby a system with a plurality of wireless integrated sensor network continuously monitoring plants for pestilence and other plant harms can timely raise alerts of found labeled positively identified insects or plant harm without human visual intervention, alerts retaining sensor meta data, time and location of sensor data triggering image alert.

2. A system as in claim 1 further comprising AI machine learning implemented algorithms from a set of machine learning algorithms for identifying image objects including Dimensionality reduction, Ensemble learning, Meta learning, Reinforcement learning, Supervised learning, Unsupervised learning, Semi-supervised learning, and Deep learning.

3. A system as in claim 1 further comprising integrated sensor sensors from a set of sensors including optical, multispectral, hyperspectral, fisheye lens, thermal, IR, temperature, humidity, location, light, motion and audio sensors.

4. A system as in claim 3 further comprising the optical sensor physically supported by and extended from a sticky trap base, sensor having viewing position to acquire primary image data of both trapped insects as well as the associated plant monitored.

5. A system as in claim 4 further comprising a sticky trap with base having a solar cell substrate surface substantially layered with transparent sticky, solar cell providing power to the extended sensor.

6. A system as in claim 3 further comprising integrated sensors having logic for obtaining digital differences from stored sequential images onboard, the digital differences exceeding a set byte count triggers notice of new data for an upload request.

7. A system as in claim 3 further comprising integrated sensors having logic with sufficient memory to and cpu to store more than one primary sensor image, logic from downloaded and installed specific threat label trained AI analytic identifying specific known and trained for threat objects in sensed image artifacts or objects in sensed image data onboard the sensor, sending notification of the found matches to the hub.

8. A system as in claim 1 further comprising audio sensors with filter and signal threshold logic.

9. A system as in claim 1 wherein the image data acquired from integrated sensor data remains digitally linked with associated metadata containing at least sensor data time, location, date and type of plant monitored.

10. A system as in claim 1 further comprising non-experts with access to exemplars from Internet services, libraries, or system owners.

11. A system as in claim 1 further comprising integrated sensors with power off and on logic minimizing sensor power for use in intermittent data collection and transmission functions.

12. A method for adapting an in situ wireless integrated sensor network with non-expert monitoring for pestilence and plant harm, to creating training data and training an AI analytic program for automated monitoring for pestilence and plant harms further comprising the steps of:
connecting a plurality of integrated sensors network wirelessly for collecting plant and insect primary sensor data in agricultural or community settings having crops;
providing logic for transmitting primary sensor data with associated sensor metadata onto a database;
partitioning primary sensor image data into insect pestilent and plant images;
having non-experts digitally bounding borders demarking a suspect object in a partitioned data image;
comparing view display exemplar images of specific identified insects and plant harms exemplars with demarked image objects;
grouping non-expert demarked objects having a positive match with a specific exemplar, into that specific exemplar's label group of positive labeled image set and non-matching image data grouped into a negative labeled image data set;
presetting a minimum numerical count for threshold of training image data set for a specified label of positive and negative data image set counts;
providing logic responsive to specified label set image count thresholds, forwarding accumulated data sets reaching threshold specific image label count as input training data to an AI machine learning program creating an trained AI analytic program capable of identifying the specific labeled image object in primary sensor data images;
installing and executing the trained AI analytic for scanning a plurality wireless sensor data images for pestilence and plant objects matching AI analytic trained on specific labeled objects, and
AI analytic raising alerts for matching identified objects in sensor data images,
whereby a system with a plurality of wireless integrated sensor network is continuously monitoring plants for pestilence and other plant harms for raising timely alerts of found positively identified insects or plant harms, without human visual intervention, alerts retaining sensor meta data, time and location of sensor data triggering image alert.

13. A method as in claim 12 further comprising the steps of implementing AI machine learning implemented algorithms from a set of machine learning algorithms for identifying image objects including Dimensionality reduction, Ensemble learning, Meta learning, Reinforcement learning, Supervised learning, Unsupervised learning, Semi-supervised learning, and Deep learning.

14. A method as in claim 12 further comprising the steps of integrating sensor components from a set of sensor components including optical, multispectral, hyperspectral, fisheye lens, thermal, IR, temperature, humidity, location, light, motion and audio sensors.

15. A method as in claim 12 further comprising the steps of physically supporting an optical sensor from a sticky trap base, with sensor having viewing position to acquire primary image data of both trapped insects as well as the associated plant monitored.

16. A method as in claim 12 further comprising the steps of providing a base having a solar cell substrate surface substantially layered with transparent sticky, solar cell providing power to the extended sensor.

17. A method as in claim 12 further comprising the steps of providing logic to integrated sensors, logic for obtaining digital differences from stored sequential images onboard the sensor, with the digital differences exceeding a set byte count triggering notice of new data and an upload request.

18. A method as in claim 12 further comprising the steps of integrating sensors with logic, sufficient memory and cpu to store more than one primary sensor image and for downloading and installing specific threat label trained AI analytic for identifying specific known and trained objects in sensed image artifacts or objects from sensed image data onboard the sensor, sending notification of the found matches to the hub.

19. A method as in claim 12 wherein the image data acquired from integrated sensor data remains digitally linked with associated metadata containing at least sensor data time, location, date and type of plant monitored.

20. A method as in claim 12 further comprising the steps of providing integrated sensor logic for integrated sensor intermittent use, powering off and on for data collection and transmission.
